(19) United States
(12) Patent Application Publication
(10) Pub. No.: US 2006/0141298 A1
(43) Pub. Date: Jun. 29, 2006

(54) Solenoid-operated valve for fuel cells

(75) Inventors: Kazuki Ishikawa, Utsunomiya-shi (JP); Yoshio Saito, Iwanuma-shi (JP); Takashi Iwamura, Haga-gun (JP); Hiroyasu Ozaki, Utsunomiya-shi (JP); Tatsuya Sugawara, Kawachi-gun (JP)

Correspondence Address: LAHIVE & COCKFIELD, 28 STATE STREET, BOSTON, MA, 02109, US

(73) Assignee: Keihin Corporation, Shinjuku-Ku (JP)

(21) Appl. No.: 11/292,056

(22) Filed: Nov. 30, 2005

(30) Foreign Application Priority Data
Nov. 30, 2004 (JP) 2004-346027

(51) Int. Cl. H01M 8/00

(52) U.S. Cl. 429/12

(57) ABSTRACT

A first port for introducing hydrogen is defined in a side wall of a first valve body, and a hot water passage for passing therethrough hot water to heat a region in the vicinity of the first port is defined in the first valve body above the first port. The first valve body has a recess defined therein at a position facing a valve head of a valve mechanism, providing a clearance between the valve head and the first valve body when the valve head is unseated from a seating surface. A solenoid unit includes a movable core having a land which faces a recess defined in a shaft guide. An elastic member made of an elastic material is mounted on the land.

### BACKGROUND OF THE INVENTION

1. Field of the Invention

The present invention relates to a solenoid-operated valve for discharging a reaction gas from fuel cells of a fuel cell system.

2. Description of the Related Art

Heretofore, solid polymer membrane fuel cell devices have a stack of cells (hereinafter referred to as a fuel cell stack) each comprising a solid polymer electrolyte membrane sandwiched between an anode and a cathode that are disposed one on each side of the solid polymer electrolyte membrane. When hydrogen is supplied as a fuel to the anode and air is supplied as an oxidizing agent to the cathode, hydrogen ions are generated at the anode by a catalytic reaction, and move through the solid polymer electrolyte membrane to the cathode where they cause an electrochemical reaction to generate electric power.

The fuel cell devices are combined with an air compressor for supplying air as a reaction gas to the cathodes and a pressure control valve for supplying hydrogen as a reaction gas to the anodes. The pressure of the reaction gas supplied to the anodes with respect to the pressure of the reaction gas supplied to the cathodes is adjusted to a predetermined pressure for thereby achieving a predetermined power generation efficiency, and the flow rate of the reaction gas supplied to the fuel cell stack are controlled to obtain a desired fuel cell output.

KEIHIN CORPORATION has proposed a solenoid-operated valve which can stably and smoothly be opened and closed at low temperatures for appropriately discharging a reaction gas from fuel cell devices (Japanese Laid-Open Patent Publication No. 2004-179118).

One known prior invention relevant to the present invention is concerned with a fuel cell system having a check valve that is inserted in a hydrogen return line thereof and selectively openable and closable by a controller for preventing excessive hydrogen from being recirculated and also preventing fresh hydrogen from being discharged out of the fuel cell system while hydrogen is being purged, thereby to reliably purge hydrogen and prevent fresh hydrogen from being wasted (see, for example, Japanese Laid-Open Patent Publication No. 2002-93438).

### SUMMARY OF THE INVENTION

It is a general object of the present invention to provide a solenoid-operated valve having a valve head which can smoothly be displaced at low temperatures for discharging a reaction gas from fuel cells.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of a fuel cell system which incorporates a solenoid-operated valve for fuel cells according to an embodiment of the present invention;

FIG. 2 is a plan view of the solenoid-operated valve according to the embodiment of the present invention;

FIG. 3 is side elevational view of the solenoid-operated valve shown in FIG. 2;

FIG. 4 is a vertical cross-sectional view taken alone line IV-IV of FIG. 2;

FIG. 5 is a vertical cross-sectional view of the solenoid-operated valve shown in FIG. 4 when it is opened;

FIG. 6 is a vertical cross-sectional view, partly omitted from illustration, taken alone line VI-VI of FIG. 2; and

FIG. 7 is an enlarged vertical cross-sectional view of a valve head according to a modification, which has an upper surface tapered toward a first valve body, incorporated in the solenoid-operated valve shown in FIG. 4.

### DESCRIPTION OF THE PREFERRED EMBODIMENT

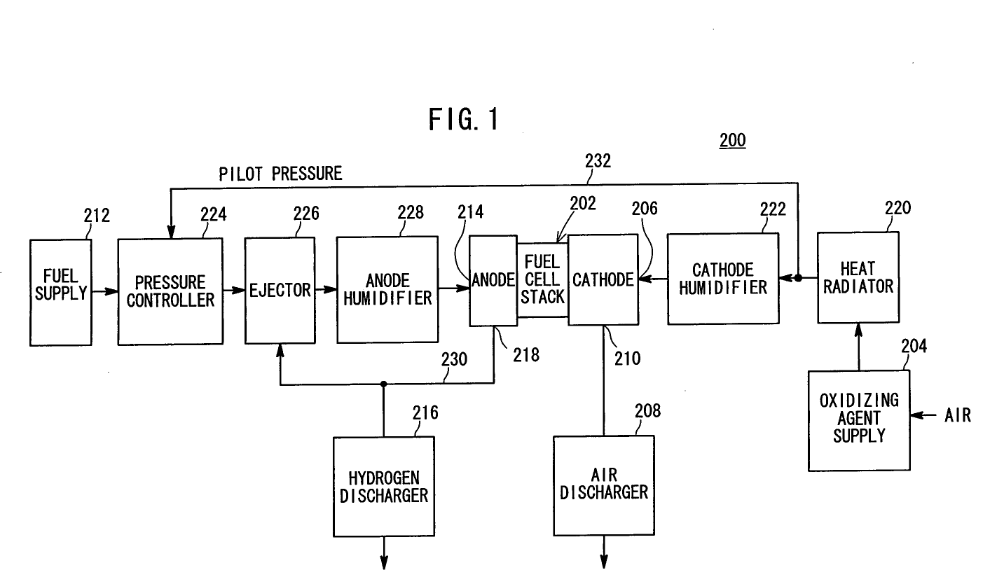

FIG. 1 is a block diagram of a fuel cell system 200 which incorporates a solenoid-operated valve for fuel cells according to an embodiment of the present invention. The fuel cell system 200 is mounted on a vehicle such as an automobile or the like. As shown in FIG. 1, the fuel cell system 200 includes a fuel cell stack 202 having a stack of cells each comprising a solid polymer electrolyte membrane sandwiched between an anode and a cathode that are disposed one on each side of the solid polymer electrolyte membrane. The fuel cell stack 202 has an anode supplied with hydrogen as a fuel and a cathode supplied with air including oxygen, for example, as an oxidizing agent. A reaction gas used in the embodiment collectively refers to hydrogen and air or hydrogen and excessive hydrogen in air.

The cathode has an air supply port 206 for being supplied with air from an oxidizing agent supply 204 and an air discharge port 210 connected to an air discharger 208 for discharging air in the cathode. The anode has a hydrogen supply port 214 for being supplied with hydrogen from a fuel supply 212 and a hydrogen discharge port 218 connected to a hydrogen discharger 216.

The fuel cell stack 202 is arranged such that hydrogen ions generated at the anode by a catalytic reaction move through the solid polymer electrolyte membrane to the cathode where they cause an electrochemical reaction with oxygen to generate electric power.

To the air supply port 206, there are connected the oxidizing agent supply 204, a heat radiator 220, and a cathode humidifier 222 by an air supply passage. The air discharger 208 is connected to the air discharge port 210 by an air discharge passage.

To the hydrogen supply port 214, there are connected the fuel supply 212, a pressure controller 224, an ejector 226, and an anode humidifier 228 by a hydrogen supply passage. The hydrogen discharger 216 is connected to the hydrogen discharge port 218 by a circulation passage 230.

The oxidizing agent supply 204 comprises, for example, an air compressor and a motor for actuating the air compressor (not shown). The oxidizing agent supply 204 adiabatically compresses air, which is to be used as an oxidizing gas in the fuel cell stack 202, and supplies the compressed air to the fuel cell stack 202.

The air supplied from the oxidizing agent supply 204 is set to a certain pressure depending on the load on the fuel cell stack 202 or the amount of depression of an accelerator pedal (not shown), for example, before it is introduced into the fuel cell stack 202.

The heat radiator 220 comprises an intercooler or the like (not shown), for example, and cools the air supplied from the oxidizing agent supply 204 during normal operation of the fuel cell stack 202 through a heat exchange with cooling water which flows through a flow passage. Therefore, the supplied air is cooled to a predetermined temperature and then introduced into the cathode humidifier 222.

The cathode humidifier 222 has a water-permeable membrane, for example. The cathode humidifier 222 humidifies the air, which has been cooled to the predetermined temperature by the heat radiator 220, to a certain humidity by passing water from one side of the water-permeable membrane to the other, and supplies the humidified air to the air supply port 206 of the fuel cell stack 202. The humidified air is supplied to the fuel cell stack 202 to keep the ion conductivity of the solid polymer electrolyte membranes of the fuel cell stack 202 in a predetermined state.

The air discharger 208 connected to the air discharge port 210 of the fuel cell stack 202 has a discharge valve (not shown) which discharges the air into the atmosphere.

The fuel supply 212 comprises a hydrogen gas container (not shown) for supplying hydrogen as a fuel to the fuel cells, for example. The fuel supply 212 stores hydrogen that is to be supplied to the anode of the fuel cell stack 202.

The pressure controller 224 comprises a pneumatic proportional pressure control valve, for example, and sets a secondary pressure that is the pressure from the outlet of the pressure controller 224 to a pressure within a predetermined range.

The ejector 226 comprises a nozzle and a diffuser (not shown). The fuel (hydrogen) supplied from the pressure controller 224 to the ejector 226 is accelerated when it passes through the nozzle, and ejected toward the diffuser. When the fuel flows at a high speed from the nozzle to the diffuser, a negative pressure is developed in an auxiliary chamber disposed between the nozzle and the diffuser, attracting the fuel discharged from the anode through the circulation passage 230. The fuel and the discharged fuel that are mixed together by the ejector 226 are supplied to the anode humidifier 228. The fuel discharged from the fuel cell stack 202 circulates through the ejector 226.

Therefore, the unreacted gas discharged from the hydrogen discharge port 218 of the fuel cell stack 202 is introduced through the circulation passage 230 into the ejector 226. The hydrogen supplied from the pressure controller 224 and the gas discharged from the fuel cell stack 202 are mixed with each other and supplied again to the fuel cell stack 202.

The anode humidifier 228 has a water-permeable membrane, for example. The anode humidifier 228 humidifies the fuel, which has been delivered from the ejector 226, to a certain humidity by passing water from one side of the water-permeable membrane to the other, and supplies the humidified fuel to the hydrogen supply port 214 of the fuel cell stack 202. The humidified hydrogen is supplied to the fuel cell stack 202 to keep the ion conductivity of the solid polymer electrolyte membranes of the fuel cell stack 202 in a predetermined state.

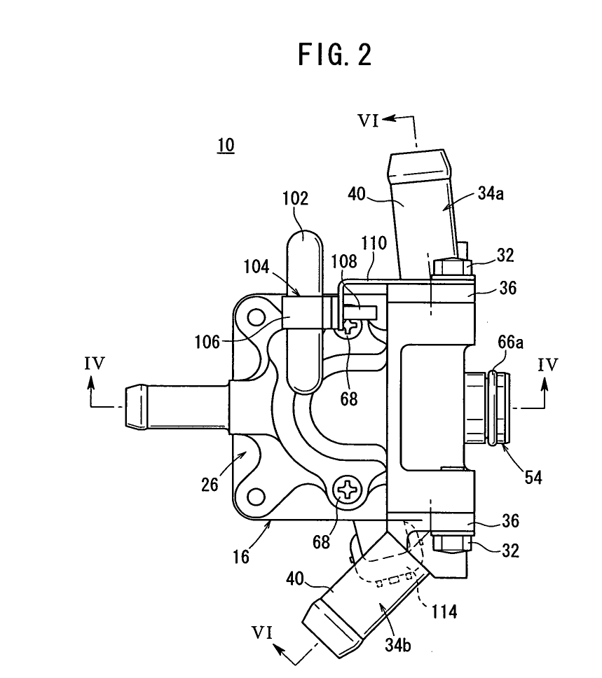

The hydrogen discharger 216 which is connected to the hydrogen discharge port 218 of the fuel cell stack 202 by the circulation passage 230 discharges excessive hydrogen from the fuel cell stack 202 out of the fuel cell system 200. The hydrogen discharger 216 has a solenoid-operated valve 10 (see FIG. 2) which can be opened and closed depending on an operating state of the fuel cell stack 202 for discharging hydrogen from the fuel cell stack 202 out of the fuel cell system 200. The solenoid-operated valve 10 discharges the reaction gas.

The solenoid-operated valve 10 which is incorporated in the fuel cell system 200 will be described in detail below with reference to the drawings.

As shown in FIGS. 2 through 5, the solenoid-operated valve 10 includes a valve housing 16 having a first port 12 for introducing hydrogen (reaction gas) and a second port 14 for discharging the hydrogen. The solenoid-operated valve 10 also has a casing 18 formed of a thin sheet of metallic material and integrally joined to a lower portion of the valve housing 16, a solenoid unit 20 disposed in the casing 18, and a valve mechanism 22 for switching the first and second ports 12, 14 into and out of communication with each other in response to energization of the solenoid unit 20.

The valve housing 16 is integrally joined to an upper portion of the casing 18. The valve housing 16 comprises a first valve body 26 which has the first port 12 for introducing hydrogen and a hot water passage 24 for passing hot water therethrough, and a second valve body 28 which has the second port 14 for discharging the hydrogen that is introduced into the valve housing 16 from the first port 12.

The first valve body 26 has a first communication chamber 30 defined substantially centrally therein for introducing hydrogen therein. The first port 12 is defined in a side wall of the first valve body 26 for introducing hydrogen into the first communication chamber 30.

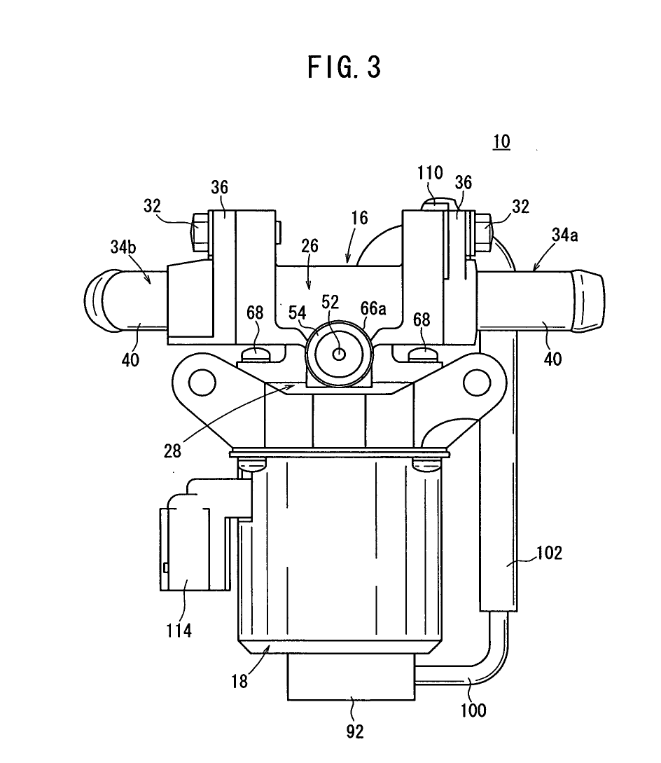

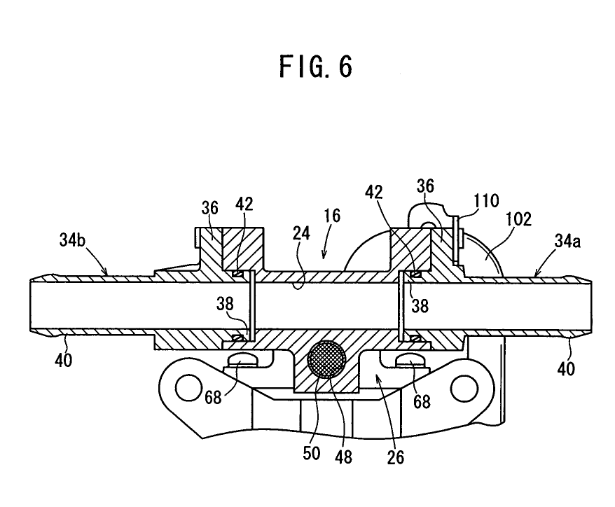

The hot water passage 24 for being supplied with hot water through a hot water pipe (not shown) is defined substantially horizontally in an upper portion of the first valve body 26. As shown in FIG. 6, the hot water passage 24 extends substantially straight between opposite side surfaces of the first valve body 26. Joints 34a, 34b are fastened to the opposite side surfaces of the first valve body 26 where the hot water passage 24 is open, by bolts 32 (see FIG. 3). Since the hot water passage 24 extends substantially straight in the upper portion of the first valve body 26, the hot water passage 24 can easily be formed. Therefore, the solenoid-operated valve 10 can be manufactured at a reduced cost with a shortened process.

The joints 34a, 34b are made of a metallic material such as stainless steel, for example. Each of the joints 34a, 34b comprises a substantially flat attachment 36 mounted on a side surface of the first valve body 26, an insert 38 extending substantially perpendicularly from the attachment 36 and inserted into the hot water passage 24, and a connector 40 extending from the attachment 36 remotely from the insert 38 for connection to the hot water pipe (not shown), such as a hose, for example.

When the inserts 38 of the joints 34a, 34b are inserted into the hot water passage 24, and the attachments 36 thereof are fastened to the respective side surfaces of the first valve body 26 by the bolts 32, the hot water passage 24 in the first valve body 26 and the connectors 40 of the joints 34a, 34b are held in communication with each other. Therefore, hot water supplied from the non-illustrated hot water pipe flows through one of the joints 34a, 34b into the hot water passage 24. O-rings 42 are mounted in respective annular grooves defined in the outer circumferential surfaces of the inserts 38 and held against inner surfaces of the first valve body 26. The O-rings 42 are effective to prevent hot water from leaking out from regions between the inserts 38 and the hot water passage 24.

Since hot water flows through the hot water passage 24 disposed near the first port 12 for introducing hydrogen, the first valve body 26 around the hot water passage 24 is heated to a certain temperature. Consequently, a restriction 54 and a filter 50 which are disposed in the first port 12 and a first passage 48 are prevented from being frozen at low temperatures in a cold climate or the like. As a result, hydrogen is reliably and appropriately introduced through the first port 12 and the first passage 48 into the first communication chamber 30.

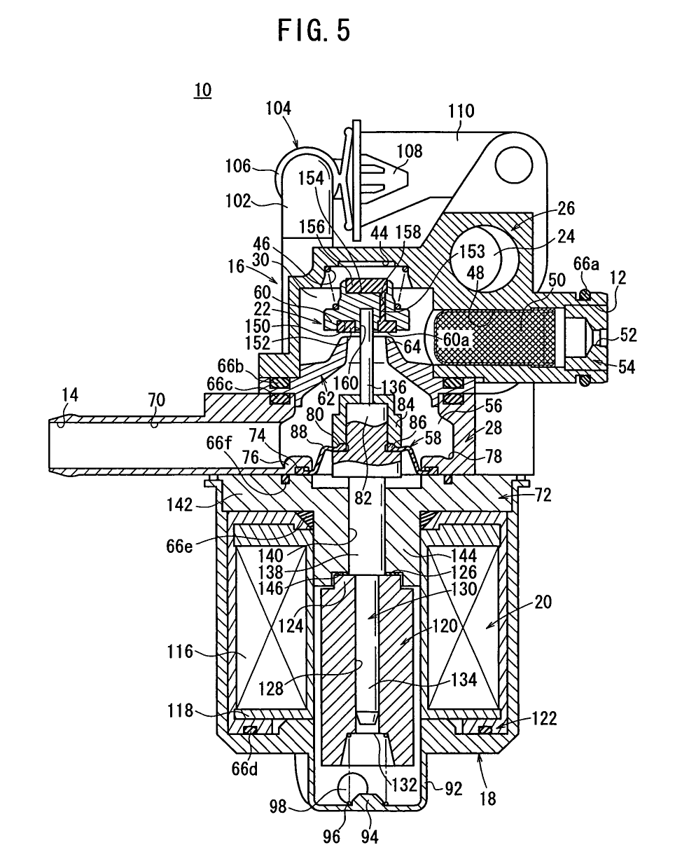

An annular recess 44 having a certain depth is defined in an inner surface of the first valve body 26 at a position facing a valve head 60 of the valve mechanism 22. A return spring 46 is interposed between the inner surface of the first valve body 26 in the vicinity of the recess 44 and the valve head 60. The depth of the recess 44 is set to such a value that when the valve head 60 is unseated from a valve seat 62 as shown in FIG. 5, a predetermined axial clearance is created between the upper surface of the valve head 60 and the bottom surface of the recess 44.

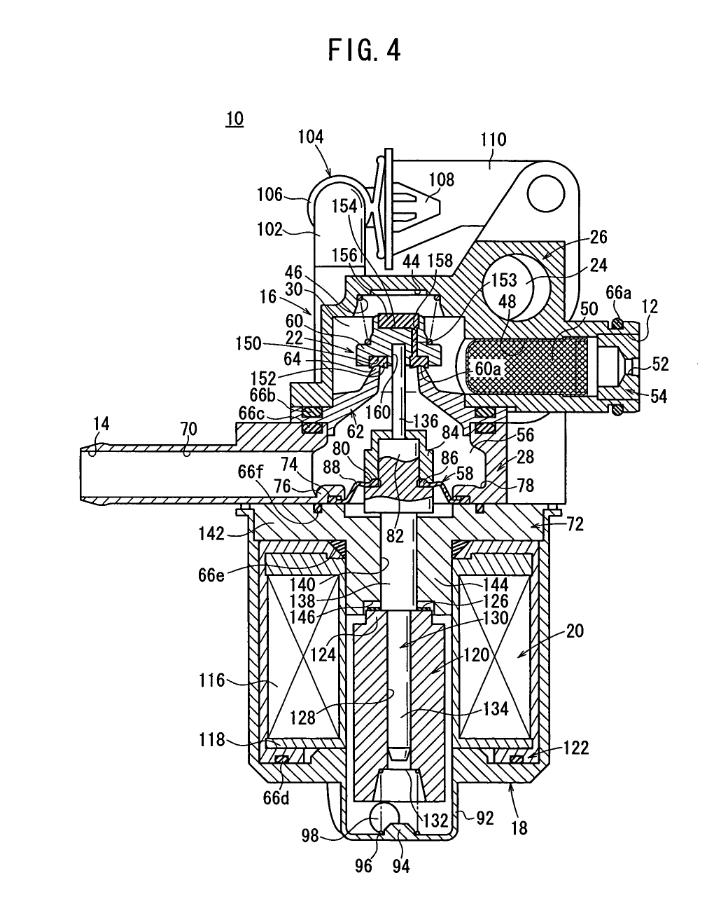

As shown in FIG. 4, a filter 50 comprising a bottomed cylindrical member is mounted in a first passage 48 which interconnects the first port 12 and the first communication chamber 30. A restriction 54 having an orifice 52 for restricting the flow rate of hydrogen supplied through the orifice 52 to the first communication chamber 30 is mounted in an opening of the first port 12 such that the orifice 52 is disposed upstream of the filter 50. The filter 50 and the restriction 54 are press-fitted in and along the inner circumferential surfaced of a tube which defines the first passage 48 therein, and are disposed coaxially in line with each other. The filter 50 has a plurality of fine pores having a pore size of 100 μm or less, preferably 80 μm or less.

Since the restriction 54 with the orifice 52 is disposed in the first port 12, the flow rate of hydrogen flowing from the first port 12 toward the second port 14 is limited, reducing a load imposed on a diaphragm 58 that is disposed in a second communication chamber 56 in the second valve body 28. Stated otherwise, the fluid (hydrogen) under pressure flowing through the second communication chamber 56 is depressurized, preventing the diaphragm 58 from being deformed beyond an allowable range for increased durability thereof.

When dust or the like enters the solenoid-operated valve 10 from the first port 12, the filter 50 mounted in the first passage 48 prevents the introduced dust or the like from entering the first communication chamber 30, and hence from being attached to an abutment surface 60a of the valve head 60 (to be described later) disposed in the first communication chamber 30 or a seating surface 64 of a valve seat 62, to be described later. Consequently, the hermetic sealing capability that is achieved when the valve head 60 is seated on the seating surface 64 is prevented from being lowered by dust or the like.

Since the restriction 54 with the orifice 52 is disposed upstream of the filter 50, excessive humidifying water is prevented from being introduced into the filter 50, thereby reducing the possibility of clogging of the filter 50 with water droplets produced from the humidifying water or ice formed when such water droplets are frozen.

A seal member 66a is mounted in an annular groove defined in the outer circumferential surface of the first port 12. When a tube, not shown, is mounted on the first port 12, the seal member 66a is sandwiched between the inner circumferential surface of the tube and the outer circumferential surface of the first port 12, providing a hermetic seal for the hydrogen that flows through the tube.

As shown in FIGS. 2 and 3, the second valve body 28 is integrally fastened to a lower portion of the first valve body 26 by screws 68. As shown in FIGS. 4 and 5, the second valve body 28 has the second communication chamber 56 defined substantially centrally therein for introducing hydrogen therein through the first communication chamber 30 and the second port 14 defined in a side wall of the second valve body 28 for discharging the hydrogen that has been introduced into the second communication chamber 56.

The second port 14 is defined so as to project radially outwardly from the side wall of the second valve body 28, and communicates with the second communication chamber 56 through a second passage 70 defined in the second port 14.

The diaphragm 58 disposed in the second communication chamber 56 is clamped between the second valve body 28 and a shaft guide 72 (to be described later) of the solenoid unit 20. Specifically, the diaphragm 58 has a peripheral edge portion 74 extending radially outwardly and is clamped between a retainer 76 projecting radially inwardly from an inner wall surface of the second communication chamber 56 and the shaft guide 72. With this structure, the second communication chamber 56 provides a radially greater inner space than a conventional solenoid-operated valve wherein the diaphragm 58 is clamped between an end face of the second valve body 28 and an end face of the shaft guide 72.

Consequently, when water is introduced into the second communication chamber 56 by humidified hydrogen introduced from the fuel cell stack 202 (see FIG. 1), the level of water accumulated in the second communication chamber 56 is kept to a lower position, and the accumulated water is prevented from being attached to the diaphragm 58.

An annular groove 78 with a predetermined depth extending toward the shaft guide 72 is defined between an inner wall surface of the second communication chamber 56 and the retainer 76. The annular groove 78 serves to hold water that has entered the second communication chamber 56. As a result, no water is applied to the diaphragm 58, and the diaphragm 58 is prevented from suffering an operation failure which would otherwise occur if water attached thereto is frozen.

The diaphragm 58 is of an integral double-layer structure which comprises, for example, a high-strength base fabric covered with a thin elastic layer of nitride rubber (NBR), and hence has high durability. As a result, the diaphragm 58 is improved in pressure resistance because of its structure as well as its durability due to reduction of the pressure of the fluid introduced into the second communication chamber 56.

The diaphragm 58 has a substantially central clamped portion 86 that is clamped between a step 80 of a shaft 130, to be described later, and a press-fitted fixture 84 that is press-fitted over an enlarged end 82 of the shaft 130, a bent portion 88 flexibly extending radially outwardly from the clamped portion 86, and a peripheral edge portion 74 formed on an outer peripheral edge of the bent portion 88.

Since the clamped portion 86 of the diaphragm 58 is clamped between the step 80 of the shaft 130 and the press-fitted fixture 84, the diaphragm 58 provides a sealing function to keep the second communication chamber 56 hermetically sealed appropriately for preventing the hydrogen from leaking into the solenoid unit 20.

When water enters the second communication chamber 56, the diaphragm 58 prevents such water from going into the solenoid unit 20, and hence no water is frozen between the shaft guide 72 and the shaft 130 at low temperatures such as in a cold climate. The shaft 130 is thus allowed to move smoothly because no water is frozen between the shaft guide 72 and the shaft 130.

Furthermore, since water in the second communication chamber 56 is reliably prevented by the diaphragm 58 from entering the solenoid unit 20, a movable core 120 which is made of a magnetic metallic material and the shaft 130 which is made of a nonmagnetic metallic material are prevented from developing rust, but have better durability.

When worn-off particles are produced by sliding motion of the shaft 130 through a guide hole 140 defined in the shaft guide 72, dust particles such as worn-off particles are prevented by the diaphragm 58 from entering the second communication chamber 56. As a result, dust particles such as worn-off particles do not flow from the second communication chamber 56 through the second port 14 into a downstream region in the fuel cell system 200 (see FIG. 1).

The valve seat 62, which is progressively tapered toward the valve head 60, is mounted on the upper portion of the second valve body 28, and has a peripheral edge sandwiched between the second valve body 28 and a lower surface of the first valve body 26. The interior of the first valve body 26 is hermetically sealed by a seal member 66b that is mounted in an annular groove defined in an upper surface of the valve seat 62.

The valve seat 62 is progressively smaller in diameter in the upward direction and has on its upper end face the seating surface 64 which lies substantially horizontally for the valve head 60 to be seated thereon.

A seal member 66c is mounted in an annular groove defined in the upper surface of the second valve body 28. The valve seat 62 has its lower surface held against the seal member 66c, hermetically sealing the interior of the second communication chamber 56 which communicates with the interior of the valve seat 62.

The seating surface 64 has an end face confronting the valve head 60 and located upwardly of the lower side of an inner circumferential surface of the first passage 48. Specifically, since hydrogen introduced from the fuel cell stack 202 (see FIG. 1) into the first communication chamber 30 contains water as it is humidified, such water tends to be trapped in the first communication chamber 30. The level of the water trapped in the first communication chamber 30 is substantially at the same height as the lower side of the inner circumferential surface of the first passage 48. Stated otherwise, when the amount of water trapped in the first communication chamber 30 exceeds a certain amount, it is discharged out through the first passage 48. Water will not be accumulated in the first communication chamber 30 to a level higher than the lower side of the inner circumferential surface of the first passage 48. Therefore, the water trapped in the first communication chamber 30 does not contact the valve head 60 that is seated on the seating surface 64.

Even if the water is frozen in the first communication chamber 30 at low temperatures such as in a cold climate, the valve head 60 and the seating surface 64 are not frozen by the water, so that the valve head 60 can reliably be displaced by the shaft 130 at low temperatures.

The casing 18 is formed of a magnetic metallic material into a substantially U-shaped cross section, and is integrally joined to a lower portion of the second valve body 28. The casing 18 has a cylindrical knob 92 disposed substantially centrally and projecting downwardly a predetermined length. The cylindrical knob 92 has an inside diameter greater than the outside diameter of the movable core 120, to be described later. Specifically, the diameter of the cylindrical knob 92 is selected to allow the movable core 120 to be displaced axially in the cylindrical knob 92 when the movable core 120 is displaced upon energization of the solenoid unit 20. Since only the cylindrical knob 92 projects downwardly from the casing 18, the overall structure may be smaller than if the casing 18 projects downwardly in its entirety.

An upwardly projecting spring guide 94 is disposed substantially centrally in the cylindrical knob 92, and a spring 96, to be described below, has an end engaging the spring guide 94.

An air bleeder port 98 is defined in a side surface of the cylindrical knob 92 for discharging the fluid within the casing 18. A substantially L-shaped joint pipe 100 is connected to the air bleeder port 98 outside of the cylindrical knob 92 (see FIG. 3). The joint pipe 100 is made of a metallic material (e.g., stainless steel) and has an end portion connected to the air bleeder port 98 and another end portion oriented vertically upwardly. A tube 102 made of an elastic material such as rubber or the like is connected to the other end portion of the joint pipe 100, so that the joint pipe 100 is vented to the atmosphere through the tube 102.

The tube 102 extends vertically upwardly, is bent substantially horizontally, and then extends vertically downwardly toward the first valve body 26. A fixing clip 104 is mounted on the portion of the tube 102 which is bent substantially horizontally. The fixing clip 104 comprises an annular support 106 surrounding the outer circumferential surface of the tube 102, and a sharply pointed protrusion 108 projecting away from the support 106. The protrusion 108 engages in a hole (not shown) defined in a plate-like fixing stay 110. As the fixing stay 110 is secured between the attachment 36 of the joint 34a and the first valve body 26, the tube 102 is held on the first valve body 26 by the fixing stay 110.

When a coil 116 of the solenoid unit 20 is supplied with a current, the coil 116 is energized and heated. As the coil 116 is heated, the fluid in the space in the casing 18 in which the solenoid unit 20 is disposed has its temperature increased and is expanded, increasing its volume. Since the space communicates with the atmosphere through the air bleeder port 98 and the joint pipe 100, the fluid expanded in the space is discharged out of the solenoid-operated valve 10.

As a result, a pressure buildup which would be developed in the casing 18 due to the expansion of the fluid is prevented, thereby preventing the diaphragm 58 from being displaced upwardly and also preventing the shaft 130 from being displaced upwardly. The valve head 60 is thus prevented from being unseated from the seating surface 64 and opened by being pushed under a pressure buildup.

The air bleeder port 98 also functions as a bleeder port for discharging air in the solenoid unit 20 out of the casing 18 when the movable core 120 is moved axially vertically. Specifically, if the interior of the casing 18 were closed off, air remaining in the casing 18 would resist the displacement of the movable core 120, tending to prevent the movable core 120 from being displaced. The air bleeder port 98 that is vented to the atmosphere makes it possible to displace the movable core 120 axially quickly and smoothly.

A connector 114 (see FIGS. 2 and 3) for supplying a current from a power supply, not shown, to the solenoid unit 20 is mounted on a side surface of the casing 18. Leads, not shown, are connected to the connector 114 for supplying the current therethrough.

The solenoid unit 20 comprises a bobbin 118 disposed in the casing 18 and having the coil 116 wound therearound, the movable core 120 that is displaceable axially upon energization of the coil 116, and a cover 122 surrounding the bobbin 118 with the coil 116 wound therearound. The solenoid unit 20 also has the shaft guide 72 disposed to close the upper end of the casing 18, and the spring 96 interposed between the spring guide 94 of the casing 18 and the movable core 120 for normally urging the movable core 120 to move in a direction away from the cylindrical knob 92.

The bobbin 118 has a lower surface held against a lower portion of the casing 18, and has an inside diameter substantially equal to the inside diameter of the cylindrical knob 92 of the casing 18.

The movable core 120 is axially slidably disposed in the bobbin 118. The movable core 120 has its outer circumferential surface spaced a predetermined distance from the inner circumferential surface of the bobbin 118. Therefore, when the movable core 120 is axially displaced, the outer circumferential surface of the movable core 120 is kept out of contact with the inner circumferential surface of the bobbin 118, so that the movable core 120 and the bobbin 118 are prevented from abrading each other.

The movable core 120 is made of a magnetic metallic material and has a cylindrical shape. The movable core 120 has a land 124 projecting a predetermined length from an upper portion thereof. The land 124 is disposed substantially centrally on the movable core 120. An annular elastic member 126 is mounted on an end face of the land 124 which faces the shaft guide 72. The elastic member 126 is made of an elastic material such as rubber or the like, and is disposed around the shaft 130 which is inserted substantially centrally in the movable core 120. The shaft 130 has an end inserted in a through hole 128 defined in the movable core 120.

The movable core 120 has a spring retainer hole 132 defined therein below the through hole 128 in a position confronting the spring guide 94 of the casing 18. The spring retainer hole 132 is of a tapered shape progressively spreading radially outwardly from the through hole 128 in the downward direction. The spring retainer hole 132 receives therein the other end of the spring 96 that engages the spring guide 94.

The shaft 130 has a first shank 134 on one end portion thereof which is inserted in the movable core 120, and also has a second shank 136 on the other end which engages the valve head 60. The shaft 130 additionally has a third shank 138 disposed between the first shank 134 and the second shank 136 and inserted through the shaft guide 72. The enlarged end 82 with the step 80 is disposed between the second shank 136 and the third shank 138. The diameter of the shaft 130 is progressively greater in the sequence of the second shank 136, the first shank 134, and the third shank 138.

The through hole 128 in which the shaft 130 is inserted has an inside diameter slightly greater than the diameter of the first shank 134 that is inserted in the through hole 128. For assembling the movable core 120 on the shaft 130, the through hole 128 in the movable core 120 is fitted over the first shank 134 until the upper end of the movable core 120 abuts against the end face of the third shank 138. The spring 96 is interposed between the spring retainer hole 132 and the spring guide 94, pressing the upper end face of the movable core 120 against the end face of the third shank 138 of the shaft 130 under the resiliency of the spring 96. In this manner, the movable core 120 can easily be assembled on the shaft 130.

The outer circumferential surface of the shaft 130 has a fluorine coating thereon. Therefore, when the shaft 130 is displaced, it undergoes reduced resistance from the guide hole 140 defined in the shaft guide 72 through which the third shank 138 slides. The shaft 130 and the shaft guide 72 thus suffer reduced wear and have increased durability. At the same time, worn-off particles that are produced when the shaft 130 slides in the guide hole 140 are reduced.

The fluorine coating on the outer circumferential surface of the shaft 130 is capable of repelling water. Consequently, no water is attached to the outer circumferential surface of the shaft 130, which is thus prevented from developing rust and has increased durability.

The cover 122 is formed of a resin material and has an upper portion sandwiched between an upper portion of the bobbin 118 and the shaft guide 72 and a lower portion sandwiched between an inner circumferential portion of the casing 18 and a lower portion of the bobbin 118. The cover 122 has an outer circumferential wall sandwiched between an inner circumferential surface of the casing 18 and the bobbin 118. Therefore, the bobbin 118 with the coil 116 wound therearound is surrounded by the cover 122.

A seal member 66d is mounted in an annular groove defined in a lower surface of the cover 122. The seal member 66d is held against the casing 18 to keep the interior of the casing 18 hermetically sealed. The interior of the casing 18 is also hermetically sealed by a seal member 66e that is interposed between an inner circumferential end of the upper portion of the cover 122 and a flange 142 of the shaft guide 72.

The shaft guide 72 is formed of a magnetic metallic material into a substantially T-shaped cross section, and has the flange 142 extending radially outwardly as an enlarged portion and disposed to close the upper portion of the casing 18. The shaft guide 72 includes a guide 144 disposed beneath the flange 142 and positioned radially inwardly of, i.e., smaller in diameter than, the flange 142. The guide 144 is inserted in the bobbin 118. A seal member 66f is mounted in an annular groove defined in an upper surface of the flange 142 to keep the interior of the second communication chamber 56 hermetically sealed.

The third shank 138 of the shaft 130 is displaceably guided in the guide hole 140 that is axially defined substantially centrally in the shaft guide 72. The clearance that is created between the outer circumferential surface of the third shank 138 and the inner circumferential surface of the guide hole 140 is set to a small value (e.g., in a range from 10 to 50 μm, the shaft 130 being limited in operation in a range less than 10 μm) for more reliably allowing the shaft 130 to be axially displaced.

With the above arrangement, the valve head 60 joined to the shaft 130 can be more reliably seated on the seating surface 64, and the seated position of the valve head 60 on the seating surface 64 can be stabilized. Thus, the seating capability of the valve head 60 at low temperatures is improved.

The shaft guide 72 has a recess 146 defined in a lower surface thereof at a position facing the land 124 of the movable core 120. The depth of the recess 146 in the axial direction is substantially the same as or slightly larger than the height of the land 124 in the axial direction. The diameter of the recess 146 is greater than the diameter of the land 124. Thus, when the movable core 120 is displaced upwardly, the land 124 is inserted into the recess 146.

Since the annular elastic member 126 is mounted on the end face of the land 124, contact noise that is produced when the land 124 contacts the recess 146 is reduced, and shocks that are caused when the land 124 contacts the recess 146 are dampened. Stated otherwise, the elastic member 126 has an absorber function for absorbing shocks caused when the land 124 of the movable core 120 contact the recess 146 in the shaft guide 72.

The valve mechanism 22 is disposed in the first communication chamber 30 in the first valve body 26, and comprises the valve head 60 which connected to the shaft 130 and displaceable in the axial direction and the return spring 46 interposed between the valve head 60 and the recess 44 in the first valve body 26. The return spring 46 is of a tapered shape which is progressively smaller in diameter from the recess 44 toward the valve head 60, and normally urges the valve head 60 to move in a direction toward the seating surface 64.

The valve head 60 has a first groove 150 defined therein at a lower position facing the seating surface 64, the first groove 150 having a predetermined depth. A first seat member 152 made of an elastic material and having an annular shape is mounted in the first groove 150. The elastic material of the first seat member 152 keeps its elastic properties even at low temperatures (e.g., minus 20° C.).

When the valve head 60 is seated on the seating surface 64, the first seat member 152 is held against the seating surface 64, and is appropriately seated on and reliably seals the seating surface 64 because the first seat member 152 is made of an elastic material. Since the elastic function of the first seat member 152 is not lowered at low temperatures such as in a cold climate, the first seat member 152 can reliably seal the seating surface 64 at low temperatures.

The valve head 60 has a second groove 154 defined substantially centrally in an upper surface thereof, the second groove 154 having a predetermined depth. A second seat member 156 made of an elastic material is mounted in the second groove 154. The upper surface of the valve head 60 is treated to have a water repelling ability (e.g., a fluorine coating) to prevent water from being attached to the valve head 60. Therefore, even when the solenoid-operated valve 10 is used at low temperatures such as in a cold climate, water is prevented from being attached to and frozen on the upper surface of the valve head 60, which is allowed to move smoothly without being obstructed by frozen water. The water repelling ability given to the upper surface of the valve head 60 is not limited to a fluorine coating. Instead, the surface of the second seat member 156 may be chemically treated to prevent water from being attached thereto.

The first and second seat members 152, 156 project slightly axially from the lower and upper surfaces, respectively, of the valve head 60. The first seat member 152 that projects a predetermined distance from the lower surface of the valve head 60 can reliably be seated on the seating surface 64. After the first seat member 152 is formed so as to project a predetermined distance from the lower surface of the valve head 60, the first seat member 152 may be subsequently machined, e.g., cut off, to provide a substantially flat surface on the lower surface of the valve head 60 and an abutment surface 60a of the first seat member 152 for being seated on the seating surface 64.

Specifically, regardless of the amount of projection of the abutment surface 60a from the lower surface of the valve head 60, the abutment surface 60a may be subsequently machined into a substantially flat surface which can more reliably seal the seating surface 64. Therefore, the abutment surface 60a of the first seat member 152 can reliably be seated on the seating surface 64, thereby reliably preventing hydrogen flowing through the first communication chamber 30 from leaking out.

The abutment surface 60a of the first seat member 152 has a water repelling ability such as a fluorine coating. The water repelling ability is effective to prevent the abutment surface 60a of the first seat member 152 from sticking to the seating surface 64 the valve head 60 is displaced.

Because the water repelling ability of the first seat member 152 is effective to repel water, water is prevented from being attached to the first seat member 152. Therefore, even when the solenoid-operated valve 10 is used at low temperatures such as in a cold climate, water is prevented from being attached to and frozen on the first seat member 152, and the valve head 60 is allowed to move smoothly without being obstructed by frozen water.

The water repelling ability such as a fluorine coating or the like is not limited to the abutment surface 60a of the first seat member 152, but may be applied to the entire surfaces of the first and second seat members 152, 156, or the first and second seat members 152, 156 may be made in their entirety of a fluorine-based rubber material.

The first groove 150 and the second groove 154 which are defined in the valve head 60 communicate with each other through a molding passage 158 defined axially in the valve head 60, as shown in FIGS. 4 and 5. The molding passage 158 extends axially through the valve head 60, and interconnects the first groove 150 and the second groove 154. When the first and second seat members 152, 156 are to be molded, either the first groove 150 or the second groove 154 may be filled with an elastic material in a liquid phase, and the second groove 154 or the first groove 150 may also be filled with the elastic material through the molding passage 158.

As a result, the first and second seat members 152, 156 can integrally be molded through the molding passage 158. Therefore, the manufacturing cost of the first and second seat members 152, 156 can be reduced, and the process of molding the first and second seat members 152, 156 can be shortened.

Inasmuch as the first and second seat members 152, 156 are joined to each other by the elastic material that is filled in the molding passage 158, the first and second seat members 152, 156 are prevented from being dislodged from the first groove 150 and the second groove 154, respectively, by a joint 153 made up of the elastic material filling the molding passage 158.

The valve head 60 has an engaging hole 160 defined substantially centrally in the lower surface thereof, and the second shank 136 of the shaft 130 is inserted in the engaging hole 160. The engaging hole 160 has a diameter greater than the diameter of the second shank 136, so that the second shank 136 engages in the engaging hole 160 with a radial clearance between the outer circumferential surface of the second shank 136 and the inner circumferential surface of the engaging hole 160.

Since the return spring 46 is of a tapered shape, the return spring 46 applies resilient forces in a combination of a direction to press the valve head 60 toward the shaft 130 and a direction to press the valve head 60 radially inwardly. Specifically, the valve head 60 is pressed against the shaft 130 at all times via the engaging hole 160 and also pressed radially inwardly at all times under the resilient forces of the return spring 46. Therefore, the second shank 136 engaging the valve head 60 is appropriately held in the engaging hole 160 for protection against being dislodged from the engaging hole 160.

As a result, even when the shaft 130 that is axially displaced when the solenoid unit 20 is energized is inclined to the axis of the first and second valve bodies 26, 28 for some reasons, the valve head 60 can absorb the inclination of the shaft 130 due to the clearance defined between the engaging hole 160 and the shaft 130. Consequently, when the shaft 130 is inclined, the valve head 60 can reliably be seated on the seating surface 64 under the resilient forces of the return spring 46 without being affected by the inclination of the shaft 130.

Similarly, even when the valve head 60 is inclined to the axis of the first and second valve bodies 26, 28 for some reasons, the inclination of the valve head 60 can be absorbed by the clearance defined between the engaging hole 160 and the shaft 130. Consequently, when the shaft 130 is axially displaced, it can smoothly be axially displaced without being affected by the inclination of the valve head 60.

The solenoid-operated valve 10 according to the embodiment of the present invention is basically constructed as described above. Now, operation and advantages of the solenoid-operated valve 10 will be described below.

As shown in FIG. 1, in the fuel cell system 200, the first port 12 of the solenoid-operated valve 10 is connected by a tube, not shown, to the hydrogen discharge port 218 (see FIG. 1) for discharging hydrogen from the fuel cell stack 202.

FIG. 4 shows the solenoid-operated valve 10 when it is turned off (the solenoid-operated valve 10 is closed) with the coil 116 de-energized, i.e., not supplied with a current from the connector 114 and the first seat member 152 of the valve head 60 seated on the seating surface 64 to keep the first port 12 and the second port 14 out of communication with each other. At the time the solenoid-operated valve 10 is turned off, the power supply, not shown, is turned on to supply a current to the coil 116 to energize the coil 116, generating magnetic fluxes which flow from the coil 116 to the movable core 120 and then back to the coil 116.

As shown in FIG. 5, the movable core 120 is displaced axially upwardly, causing the shaft 130 inserted in the movable core 120 to move the valve head 60 away from the seating surface 64 against the resilient forces of the return spring 46. When the valve head 60 is displaced upwardly until the elastic member 126 on the land 124 of the movable core 120 abuts against the recess 146 in the shaft guide 72, the elastic member 126 dampens shocks, reducing contact noise that is produced when the elastic member 126 abuts the recess 146.

As a result, the solenoid-operated valve 10 switches from the turned-off state to a turned-on state (the solenoid-operated valve 10 is open). Excessive hydrogen in the fuel cell stack 202 is discharged from the hydrogen discharge port 218 of the fuel cell stack 202, and is introduced via the non-illustrated tube through the first port 12 into the solenoid-operated valve 10. The hydrogen introduced from the first port 12 is restricted to a predetermined flow rate by the orifice 52 of the restriction 54 and hence is depressurized, after which the hydrogen is delivered from the first communication chamber 30 through the valve seat 62 into the second communication chamber 56. Then, the hydrogen is discharged from the second port 14.

For seating the valve head 60 again on the seating surface 64 to keep the first port 12 and the second port 14 out of communication with each other, thus turning off the solenoid-operated valve 10 from the turned-on state, the current supplied from the non-illustrated power supply to the coil 116 is cut off, de-energizing the coil 116, and the movable core 120 is displaced downwardly. Substantially at the same time, the valve head 60 is pressed downwardly under the resilient forces of the return spring 46. Under the resilient forces of the return spring 46, the valve head 60 is seated on the seating surface 64, bringing the first communication chamber 30 and the second communication chamber 56 out of communication with each other, and hence keeping the first port 12 and the second port 14 out of communication with each other.

According to the present embodiment, as described above, the elastic member 126 is mounted on the land 124 of the movable core 120 in the solenoid unit 20. Therefore, even when water enters the first and second communication chambers 30, 56, the water is prevented from being attached to the elastic member 126 by the diaphragm 58. Consequently, the elastic member 126 is prevented from being frozen at low temperatures in a cold climate. When the valve head 60 is displaced until the land 124 of the movable core 120 abuts against the recess 146 in the shaft guide 72, the elastic member 126 dampens shocks, reducing contact noise that is produced when the elastic member 126 abuts the recess 146.

The first valve body 26 closes the casing 18 with the second valve body 28, and the first valve body 26 has in its upper portion the first port 12 for introducing hydrogen therein and the hot water passage 24 for passing therethrough hot water for heating the region in the vicinity of the first port 12.

Since the first valve body 26 alone is capable of closing the casing 18 and of introducing hydrogen into the first communication chamber 30 and passing hot water, there is not required a lid which has been used to close an upper opening of the first valve body 26 in the conventional solenoid-operated valve for fuel cells. As a result, such a lid is not required separately, and the number of parts of the solenoid-operated valve and the cost thereof are reduced. Production efficiency of the solenoid-operated valve for fuel cells can be improved accordingly.

The recess 44 disposed in facing relation to the valve head 60 and having a predetermined depth is defined in the first valve body 26, and when the valve head 60 is unseated from the seating surface 64, a certain clearance is kept axially between the valve head 60 and the recess 44. Therefore, even when water contained in the high-humidity hydrogen introduced from the first port 12 into the first communication chamber 30 is attached to the upper surface of the valve head 60 and frozen at low temperatures in a cold climate, the frozen ice on the upper surface of the valve head 60 is held out of contact with the first valve body 26 when the valve head 60 is unseated upwardly from the seating surface 64. Even when water is frozen on the upper surface of the valve head 60, the valve head 60 is allowed to move smoothly in the axial direction.

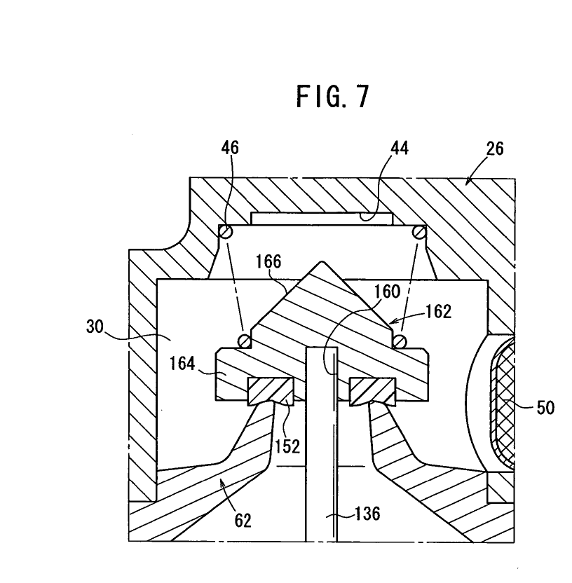

FIG. 7 shows a valve head 164 of a valve mechanism 162 according to a modification. The valve head 164 is different from the valve head 60 described above in that an upper portion thereof which faces the recess 44 in the first valve body 26 is of a tapered shape which is progressively smaller in diameter toward the recess 44.

Even when water introduced into the first communication chamber 30 is attached to the upper portion of the valve head 164, the water does not remain on the upper portion of the valve head 164, but flows down a tapered outer circumferential surface 166 of the valve head 164 by gravity. Consequently, even when the water is frozen at low temperatures in a cold climate, no frozen ice is formed between the valve head 164 and the recess 44 in the first valve body 26. The valve head 164 can thus be opened and closed smoothly axially at those low temperatures.

Although certain preferred embodiments of the present invention have been shown and described in detail, it should be understood that various changes and modifications may be made therein without departing from the scope of the appended claims.

What is claimed is:

1. A solenoid-operated valve for discharging a reaction gas from a fuel cell, comprising:
a valve housing having a first port for introducing the reaction gas and a second port for discharging the reaction gas introduced from said first port;
a solenoid unit disposed in a casing joined to said valve housing, said solenoid unit being energizable by a current;
a movable core disposed in facing relation to a fixed core disposed in said solenoid unit and displaceable axially when said solenoid unit is energized;
a shaft engaging said movable core and axially displaceable in unison with said movable core;
a valve head disposed in said valve housing and engaging an end of said shaft;
a valve seat, said valve head being seatable on and unseatable from said valve seat when said shaft is displaced;
a diaphragm disposed between said valve housing and said casing and attached to said shaft, said diaphragm being flexible in response to displacement of said shaft; and
an elastic member disposed between said movable core and said fixed core.

2. A solenoid-operated valve according to claim 1, wherein a clearance is defined between an inner wall surface of said valve housing and said valve head along a direction in which said valve head is displaced when said valve head is unseated from said valve seat.

3. A solenoid-operated valve according to claim 2, wherein said valve head has a water repelling ability on a side surface thereof which faces the inner wall surface of said valve housing.

4. A solenoid-operated valve according to claim 3, wherein said valve head has an upper portion confronting the inner wall surface of said valve housing, said upper portion being of a tapered shape which is progressively smaller in diameter toward said valve housing.

5. A solenoid-operated valve according to claim 1, further comprising a seat member mounted on said valve head and facing said valve seat, said seat member projecting from an end face of said valve head which faces said valve seat.

6. A solenoid-operated valve according to claim 1, wherein said valve head has an engaging hole defined therein, said shaft being inserted in said engaging hole, with a clearance defined between an inner circumferential surface of said engaging hole and an outer circumferential surface of said shaft.

7. A solenoid-operated valve according to claim 1, further comprising a spring interposed between said valve head and said valve housing for pressing said valve head toward said valve seat, said spring being of a tapered shape which is progressively smaller in diameter from said valve housing toward said valve head.

8. A solenoid-operated valve according to claim 1, wherein said valve housing comprises:
a first valve body having said first port; and
a second valve body having said second port and joined to said first valve body;
said valve head being disposed in said first valve body, said first valve body having a first communication chamber communicating with said first port, said second valve body having a second communication chamber communicating with said second port.

9. A solenoid-operated valve according to claim 8, wherein said first valve body has a hot water passage defined therein for passing hot water therethrough in the vicinity of said first port.

10. A solenoid-operated valve according to claim 9, wherein said valve housing has a retainer projecting radially inwardly from said valve housing and holding a peripheral edge portion of said diaphragm.

11. A solenoid-operated valve according to claim 10, wherein said second communication chamber has an annular groove defined between an inner wall surface thereof and said retainer.

12. A solenoid-operated valve according to claim 1, wherein said shaft has a water repelling ability on an outer circumferential surface thereof.

13. A solenoid-operated valve according to claim 1, further comprising a restriction mounted in said first port and having an orifice for restricting the flow rate of a reaction gas introduced into said first port.

14. A solenoid-operated valve according to claim 13, further comprising a filter mounted in said first port for removing dust particles contained in the reaction gas introduced into said first port.

15. A solenoid-operated valve according to claim 14, wherein said filter comprises a plurality of fine pores having a pore size of 100 μm or less.

16. A solenoid-operated valve according to claim 1, wherein said casing has a bleeder port for providing fluid communication between the interior and exterior of said casing.

17. A solenoid-operated valve according to claim 1, wherein said valve seat has a seating surface disposed upwardly of a lower end of an inner circumferential surface of said first port.
